(19) United States
(12) Patent Application Publication
(10) Pub. No.: US 2009/0103863 A1
(43) Pub. Date: Apr. 23, 2009

(54) MULTI-CHANNEL RING-RESONATOR BASED WAVELENGTH-DIVISION-MULTIPLEXING OPTICAL DEVICE

(75) Inventors: Jong-Moo LEE, Daejon (KR); Duk-Jun KIM, Daejon (KR); Kap-Choong KIM, Daejon (KR); Gyung-Ock KIM, Seoul (KR)

Correspondence Address: AMPACC LAW GROUP, 13024 Beverly Park Road, Suite 205, Mukilteo, WA, 98275, US

(73) Assignee: Electronics and Telecommunications Research Institute, Daejon (KR)

(21) Appl. No.: 12/111,917

(22) Filed: Apr. 29, 2008

(30) Foreign Application Priority Data
Oct. 18, 2007 (KR) 10-2007-104920

(51) Int. Cl. G02B 6/26

(52) U.S. Cl. 385/31

(57) ABSTRACT

Provided is a wavelength-division-multiplexing (WDM) device. The device includes an input waveguide, a plurality of ring resonators around the input waveguide, a plurality of output waveguides around the plurality of ring resonators, respectively, and at least one tuning clad pattern adjacent to at least one of the ring resonators, the tuning clad pattern covering a portion of a surface of a corresponding ring resonator.

### CROSS-REFERENCE TO RELATED APPLICATIONS

This U.S. non-provisional patent application claims priority under 35 U.S.C. §119 of Korean Patent Application No. 10-2007-104920, filed on Oct. 18, 2007, the entire contents of which are hereby incorporated by reference.

### BACKGROUND OF THE INVENTION

The present invention disclosed herein relates to a wavelength-division-multiplexing optical device, and more particularly, to a multi-channel ring-resonator based wavelength-division-multiplexing optical device.

The present invention has been derived from a research undertaken as a part of the information technology (IT) development, business by Ministry of Information and Communication and Institute for Information Technology Advancement, Republic of Korea (Project management No.: 2006-S-004-02, Project title: silicon based high speed optical interconnection IC).

Optical interconnection technologies are used for implementing a high bus speed of a semiconductor device such as a central processing unit (CPU). To exchange signals using the optical interconnection technologies, a wavelength-division-multiplexing device (WDM device) is required which can selectively separate light having a predetermined wavelength.

Since a ring resonator can selectively extract light having a predetermined wavelength using an optical resonance phenomenon, it is used as a means for implementing a purpose of the WDM device. For example, a method for selectively extracting light having a predetermined wavelength is disclosed in a paper entitled “Compact Wavelength-Selective Functions in Silicon-on-Insulator Photonic Wires”, W. Bogaerts et al., IEEE J. Selected Topics in Quantum Electronics, Vol. 12, No. 6, 2006.

A paper of W. Bogaerts is based on the fact that a resonant frequency is mainly determined by a radius of a ring in the ring resonator. Referring to FIG. 1, there is disclosed a method in which radii (r₁<r₂<r₃<r₄) of rings 11, 12, 13 and 14 are finely adjusted so as to selectively extract light of various wavelengths λ₁, λ₂, λ₃, and λ₄. According to the paper of W. Bogaerts et al., when a difference (e.g., r₂−r₁) between the radii of the rings 11, 12, 13 and 14 is about 20 nm, a wavelength spacing (e.g., λ₂−λ₁) of light extracted from corresponding rings is about 4 nm. A wavelength spacing of less than about 0.8 nm is generally required in a WDM optical communication system. Hence, it is difficult to apply a technique in which a wavelength spacing of about 4 nm is embodied to the WDM optical communication system.

Furthermore, although the rings are fabricated using a lithography-based technique, an error in a lithography process is expected to be greater than the allowable error range for some time. That is, since the difference of 20 nm is the feasible minimum difference between the radii of the rings in the present technique, it is technically difficult to reduce a deviation of the wavelength spacing. In this sense, the method adjusting the radii of the rings is not actually suitable for implementing a required wavelength spacing at least for some time.

### SUMMARY OF THE INVENTION

The present invention provides a wavelength-division-multiplexing device (WDM device) with a dense channel spacing.

The present invention also provides a WDM device with a dense and uniform channel spacing.

Embodiments of the present invention provide WDM devices including at least one tuning clad pattern covering a portion of a surface of a ring resonator. The device includes an input waveguide, a plurality of ring resonators around the input waveguide, a plurality of output waveguides around the plurality of ring resonators, respectively, and at least one tuning clad pattern adjacent to at least one of the ring resonators, the tuning clad pattern covering a portion of a surface of a corresponding ring resonator.

In some embodiments, when at least two tuning clad patterns are provided, the tuning clad patterns are in contact with the ring resonators adjacent thereto, respectively, and their contact areas may be different. The tuning clad pattern may be formed of at least one of materials having a refractive index less than that of the ring resonator. For example, the ring resonator may be silicon, and the tuning clad pattern may be formed of at least one of inorganic materials and organic materials having a refractive index less than that of silicon. The inorganic materials may include silicon dioxide and silicon nitride, and the organic materials may include at least one of polymethyl methacrylate (PMMA)-based polymers, polyimide-based polymers, polyether-based polymers, and acrylate-based polymers.

In other embodiments, the ring resonators may be equal in shape, material, and size.

In still other embodiments, the ring resonators may include at least one ring resonator group having at least one ring resonator. The ring resonators included in one ring resonator group may be equal in shape, material, and size, and the ring resonators included in the other ring resonator group may be different in at least one of shape, material, and size.

In other embodiments of the present invention, there are provided WDM devices in which a plurality of clad patterns have contact areas different from one another and cover surfaces of a plurality of ring resonators, respectively. The device includes an input waveguide, a plurality of ring resonators around the input waveguide, a plurality of output waveguides around the plurality of ring resonators, respectively, and a clad structure including an upper clad layer covering a surface of each of the ring resonators and at least one tuning clad pattern. A ratio between a contact area of the corresponding ring resonator and the tuning clad pattern and a contact area of the corresponding ring resonator and the upper clad layer has a different ratio at each of the ring resonators.

### BRIEF DESCRIPTION OF THE FIGURES

The accompanying figures are included to provide a further understanding of the present invention, and are incorporated in and constitute a part of this specification. The drawings illustrate exemplary embodiments of the present invention and, together with the description, serve to explain principles of the present invention. In the figures:

FIG. 1 is a plan view of a wavelength-division-multiplexing device (WDM device) having a typical ring resonator;

FIG. 2 is a plan view of a WDM optical device having a ring resonator according to an embodiment of the present invention;

FIG. 3 is a plan view of a ring resonator according to an embodiment of the present invention;

FIGS. 4 and 5 are cross-sectional views of a ring resonator according to the present invention;

FIG. 6 is a simulation graph illustrating an optical property of a ring resonator according to the present invention; and

FIG. 7 is a plan view of a WDM optical device having ring resonators according to another embodiment of the present invention.

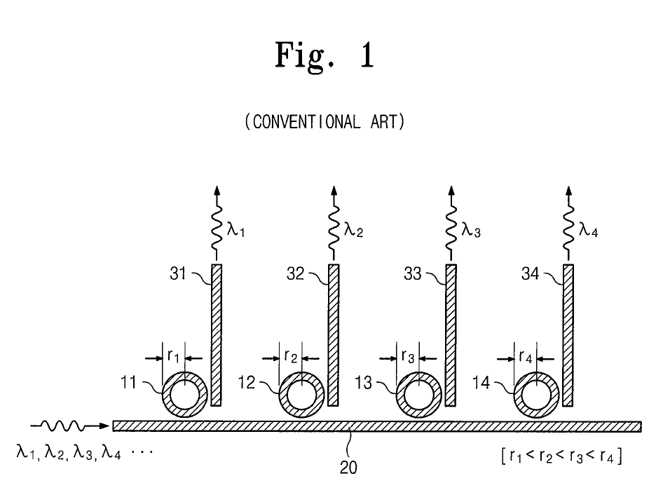

### DETAILED DESCRIPTION OF PREFERRED EMBODIMENTS

Preferred embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

In the figures, the dimensions of layers and regions are exaggerated for clarity of illustration. It will also be understood that when a layer (or film) is referred to as being ‘on’ another layer or substrate, it can be directly on the other layer or substrate, or intervening layers may also be present. Further, it will be understood that when a layer is referred to as being ‘under’ another layer, it can be directly under, and one or more intervening layers may also be present. In addition, it will also be understood that when a layer is referred to as being ‘between’ two layers, it can be the only layer between the two layers, or one or more intervening layers may also be present. Like reference numerals refer to like elements throughout.

In relation to terms, as well known, the relation among a speed of light v in a medium, the speed of light c in a vacuum and a refractive index n of a medium can be written by the equation of n=c/v; that is, the refractive index n is the ratio the speed of light c in a vacuum to the speed of light v in a medium. And, the speed of light v in the medium is the frequency of light multiplied by the wavelength of light. From these relations, an expression that specifies a predetermined wavelength may be used so as to specify a corresponding predetermined frequency.

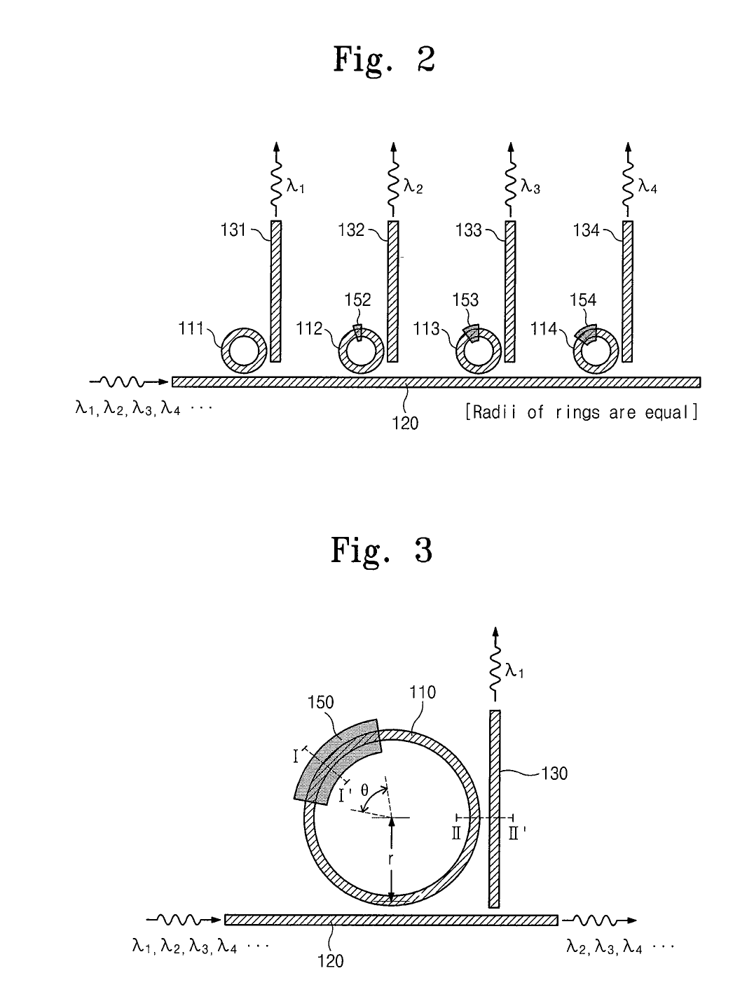

FIG. 2 is a plan view of a wavelength-division-multiplexing (WDM) optical device having a ring resonator according to an embodiment of the present invention.

Referring to FIG. 2, a WDM optical device includes at least one ring resonator (four ring resonators 111, 112, 113 and 114 are shown) disposed around at least one input waveguide 120.

The input waveguide 120 is formed of a material having a refractive index substantially different from that of a material therearound. For example, the input waveguide 120 may be silicon surrounded by silicon dioxide. Thus, the input waveguide 120 provides an optical path that can transmit light of various wavelengths λ₁, λ₂, λ₃ and λ₄ while minimizing energy losses. Although the ring resonators 111, 112, 113 and 114 is spaced from the input waveguide 120, light having a predetermined wavelength is incident from the input waveguide 120 into the ring resonator having a corresponding resonant wavelength by an optical coupling phenomenon.

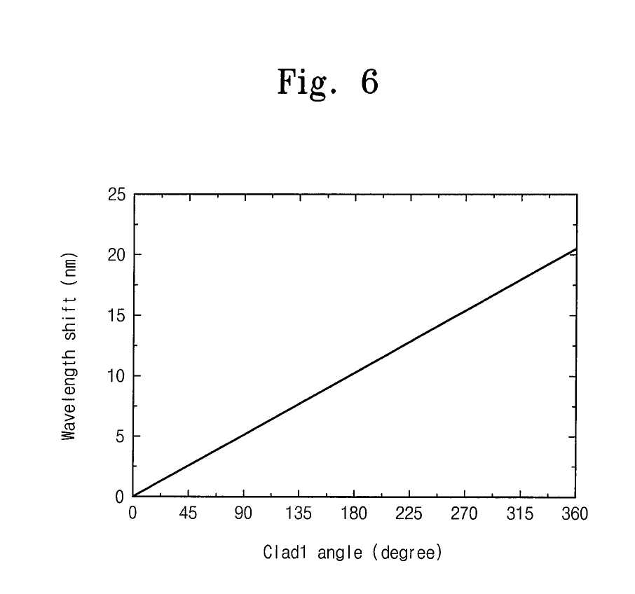

According to this embodiment, at least one tuning clad pattern (three tuning clad patterns 152, 153 and 154 are shown) is disposed circumferentially adjacent to at least one of the ring resonators 111, 112, 113 and 114. Each of the tuning clad patterns 152, 153 and 154 may have different shapes, materials, and sizes. For example, referring to FIG. 2, the tuning clad patterns 152, 153 and 154 are in contact with the ring resonators 112, 113 and 114, respectively, and their contact areas may be different. Since differences of the contact areas between the tuning clad patterns 152, 153 and 154 and the ring resonators 112, 113 and 114, as described later in detail with reference to FIG. 6, cause a fine variation of a resonant frequency of the corresponding ring resonator, light extracted through the ring resonators 111, 112, 113 and 114 have corresponding frequencies that are finely distinct from one another.

Like the ring resonator shown with reference numeral 111, the tuning clad patterns may not be disposed around at least one of the ring resonators. Existence or nonexistence of the tuning clad patterns 152, 153 and 154 may be used as one method that generates the differences of the contact areas between the tuning clad patterns 152, 153 and 154 and the ring resonators 112, 113 and 114.

According to an embodiment, the ring resonators 111, 112, 113 and 114 may be substantially equal in shape, material, and size. Hence, as described above, since the tuning clad patterns 152, 153 and 154 are substantially equal in shape, material, and size, the light extracted through each of the ring resonators 111, 112, 113 and 114 have substantially the same frequency. However, wavelengths of light actually extracted from the ring resonators 111, 112, 113 and 114 are modulated by the tuning clad patterns 152, 153 and 154, respectively.

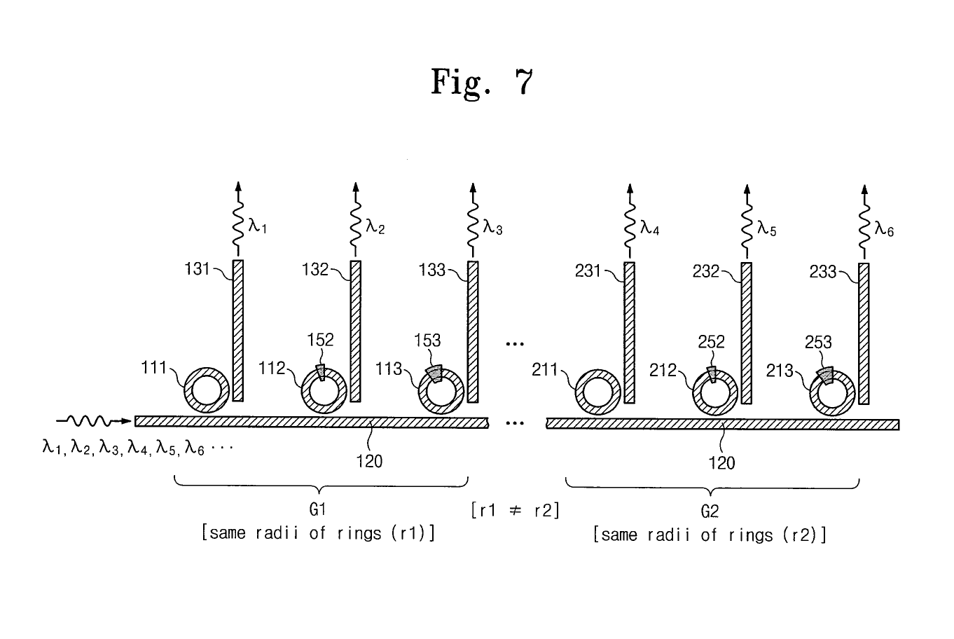

The WDM optical device does not include only ring resonators having the same structure. That is, according to another embodiment, at least one of the ring resonators 111, 112, 113 and 114 may be different in at least one of shape, material, and size. A detailed description of an exemplary embodiment will be described again with reference to FIG. 7.

At least one output waveguide (four output waveguides 131, 132, 133, are 134 are shown) is disposed adjacent to a side of each of the ring resonators 111, 112, 113 and 114. The output waveguides 131, 132, 133 and 134 transmit light within a corresponding ring resonator to the other optical device. Such process in which light are transmitted from the ring resonators 111, 112, 113 and 114 to the corresponding output waveguides 131, 132, 133 and 134, respectively has the same process as a process in which light is transmitted from the input waveguide 120 to the ring resonators 111, 112, 113 and 114. The processes are performed through the optical coupling phenomenon. The output waveguides 131, 132, 133 and 134, as illustrated in FIG. 2, are disposed in a transverse direction relative to the input waveguide 120. Like the input waveguide 120, the output waveguides 131, 132, 133 and 134 are formed of a material having a refractive index substantially different from that of a material therearound. For example, the output waveguides 131, 132, 133, and 134 may be silicon surrounded by silicon dioxide. Structures and materials of the input waveguide 120 and the output waveguides 131, 132, 133 and 134 may be variously modified as well known to those of skill in the art.

In the WDM optical device according to this embodiment, the output waveguides 131, 132, 133 and 134 disposed around the ring resonators 111, 112, 113 and 114 output light having wavelengths different from one another by selectively extracting the light through the ring resonators 111, 112, 113 and 114, as illustrated in FIG, 2. The wavelengths of light to be outputted are mainly determined by physical structures of the ring resonators 111, 112, 113 and 114. The fine differences between the outputted wavelengths are obtained through (a) difference(s) of shapes, materials, and/or sizes of the tuning clad patterns 152, 153 and 154. Hereinafter, one of methods in which differences of the tuning clad patterns 152, 153 and 154 are embodied will be exemplarily described with reference to FIG. 3.

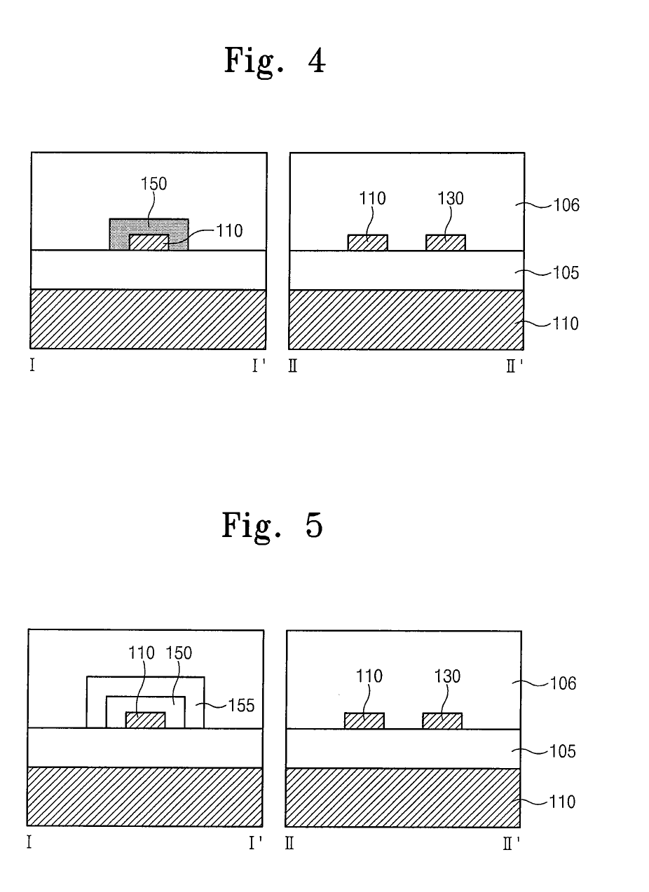

FIG. 3 is a plan view of a ring resonator according to an embodiment of the present invention, and FIGS. 4 and 5 are cross-sectional views of a ring resonator taken along dotted line I-I′ and II-II′ of FIG. 3.

Referring to FIGS. 3 and 4, a lower clad layer 105 is disposed on a substrate 100, and an input waveguide 120 and an output waveguide 130 are disposed on the lower clad layer 105. A ring resonator 110 is disposed around the input waveguide 120 and the output waveguide 130. The ring resonator 110 is spaced from the input waveguide 120 and the output waveguide 130. A tuning clad pattern 150 is disposed on the ring resonator 110. The tuning clad pattern 150 covers a predetermined region of the ring resonator 110. The input waveguide 120 is disposed in perpendicular or parallel to the output waveguide 130.

According to this embodiment, the ring resonator 110 has a circular shape having a radius r. The input waveguide 120 has the same plane as the output waveguide 130. The ring resonator 110 has the same material (e.g., silicon) as the input waveguide 120 and the output waveguide 130.

According to another embodiment, the ring resonator 110 may have various shapes such as an oval shape and a racetrack shape. The ring resonator 110 may be disposed on a plane different from the input waveguide 120 and the output waveguide 130. When ring resonator 110 is disposed on a plane different from the input waveguide 120 and the output waveguide 130, the ring resonator 110 may overlap with the input waveguide 120 and the output waveguide 130.

According to the present invention, the tuning clad pattern 150 may be formed of at least one of materials having a refractive index less than that of the ring resonator 110. For example, the ring resonator 110 may be formed of silicon. The tuning clad pattern 150 may be formed of materials having a refractive index less than that of silicon. The materials include at least one of inorganic materials such as silicon dioxide (SiO₂) and silicon oxynitride (SiON) and organic materials such as polymethyl methacrylate (PMMA)-based polymers, polyimide-based polymers, polyether-based polymers, and acrylate-based polymers. The tuning clad pattern 150 covers a portion of a surface of the ring resonator 110. For example, the tuning clad pattern 150 covers a surface of the ring resonator 110 corresponding to a range of a predetermined angle θ at the circumference, as illustrated in FIG. 3.

An upper clad layer 106 is disposed over the substrate 100. The upper clad layer 106 covers the tuning clad pattern 150 and a surface of the ring resonator 110 which is not covered by the tuning clad pattern 150. As a result, the tuning clad pattern 140 covers an upper surface and portions of sidewalls of the ring resonator 110, and the upper clad layer 106 covers the other surface except the surfaces covered by the tuning clad pattern 140.

The lower clad layer 105 and the upper clad layer 106 may be formed of materials having a refractive index less than that of the ring resonator 110. For example, the lower clad layer 105 includes at least one of SiO₂ and SiON. The upper clad layer 106 includes at least one of the inorganic materials such as SiO2 and SiON and the organic materials such as the PMMA-based polymers, the polyimide-based polymers, the polyether-based polymers, and the acrylate-based polymers. However, it is preferred that the lower clad layer 105 and the upper clad layer 106 are formed of materials having a refractive index substantially different from that of the tuning clad pattern 150.

According to another embodiment, as illustrated in FIG. 5, at least one upper tuning clad pattern 155 is further disposed on a tuning clad pattern 150. The upper tuning clad pattern more finely adjusts resonant frequency of a ring resonator 110. The upper tuning clad pattern 155 is formed of at least one of materials having a refractive index less than that of the tuning clad pattern 150. The materials include at least one of inorganic materials such as SiO2 and SiON and organic materials such as PMMA-based polymers, polyimide-based polymers, polyether-based polymers, and acrylate-based polymers.

A region in which the upper tuning clad pattern 155 is formed includes a region in which the tuning clad pattern 150. The upper tuning clad pattern 155 may cover the ring resonator 110. The ring resonator 110 can be covered by the upper clad layer 106, the tuning clad pattern 150, and the upper tuning clad pattern 155. According to a modified embodiment, the upper clad layer 106 may be used as the upper tuning clad pattern 155 without an additional upper tuning clad pattern.

FIG. 6 is a simulation graph illustrating a variation of a resonant frequency of a corresponding ring resonator according to an angle variation of a region in which (a) tuning clad pattern(s) cover(s) the ring resonator. In this simulation, it is assumed that refractive indexes of a ring resonator 110, a tuning clad pattern 150, an upper clad layer 106, and a lower clad layer 105 are about 3.45, about 1.49, about 1.45 and about 1.446, respectively. It is also assumed that a radius of the ring resonator 110 is about 6 um.

Under this condition, a difference in effective refractive indexes between in case that the tuning clad pattern 150 exists and in case that the tuning clad pattern 150 does not exist is calculated. An effective refractive index of a transverse electric (TE) mode is about 2.450113 in case that the ring resonator 110 is covered by only the upper clad layer 106 without the tuning clad pattern 150. An effective refractive index of a transverse electric (TE) mode is about 2.456735 in case that the ring resonator 110 is covered by both the tuning clad pattern 150 and the upper clad layer 106 without the tuning clad pattern 150. That is, the difference Δ Neff between two effective refractive indexes is about 0.006622.

A variation of effective refractive indexes due to the actual tuning clad pattern 150 having various areas is a product of the length ratio (i.e., θ/360) of the tuning clad pattern 150 in the circumference of the ring resonator 110 and the difference ΔNeff of the effective refractive indexes. Therefore, a variation of a resonant frequency due to the tuning clad pattern 150 is expressed as the following equation.

Δλ=0/360×ΔNeff×λ

FIG. 6 is a simulation graph illustrating results of plotting a relative variation of the resonant frequency of the ring resonator 110 according to an angle θ of the tuning clad pattern 150 occupied on the circumference of the ring resonator 110 using the above equation.

Referring to FIG. 6, the variation ratio of the resonant frequency of the ring resonator 110 according to the circumference angle θ of the tuning clad pattern 150 is about 0.057 nm/degree. Hence, when a difference of the circumference angles of the tuning clad patterns 152, 153 and 154 is about 14°, a wavelength spacing is less than about 0.8 nm. The wavelength spacing of less than about 0.8 nm is a required wavelength of light in a WDM optical communication system.

As described above, when the ring resonator 110 (i.e., core) is formed of materials having a refractive index relatively higher than that of surrounding materials, most of optical guided modes are distributed within the silicon core. Only a few optical guided modes are distributed within a cladding region surrounding the core region. Hence, an optical property of the ring resonator 110, as shown in FIG. 6, is insensitive to a variation in the cladding region. That is, the resonant frequency of the ring resonator 110 does not significantly effect on a process variation in a tuning clad pattern manufacturing process. As a result, the resonant frequency of the ring resonator 110 is finely and uniformly adjusted without the burden of the process variation. Therefore, the WDM device according to the present invention can have a dense and uniform channel spacing.

FIG. 7 is a plan view of a WDM optical device having a ring resonator according to another embodiment of the present invention. Except for the point that structures of ring resonators are different from one another, a WDM optical device according to this embodiment is the same as that of the embodiments described with reference to FIGS. 2 through 5. Thus, for a concise explanation, repetitive descriptions will be omitted.

Referring to FIG. 7, the WDM optical device includes at least one ring resonator group (e.g., as illustrated in FIG. 7, a first ring resonator group G1 and a second ring resonator group G2). Each of the ring resonator groups includes at least one ring resonator, and ring resonators in the same group are substantially equal in shape, material, and size, while ring resonators of different groups may be different in at least one of shape, material, and size.

For example, the ring resonators 111, 112 and 113 of the first ring resonator group G1 have substantially the same structure, and also the ring resonators 211, 212 and 213 of the second ring resonator group G2 have substantially the same structure. However, the ring resonators 111, 112 and 113 of the first ring resonator G1 may have ring radii r₁ different from ring radii r₂ of the ring resonators 211, 212 and 213 of the second ring resonator group G2.

As described in previous embodiments, some ring resonator group may include tuning clad patterns 152, 153, 252 and 253, which cover the corresponding ring resonators with different circumference angles (or contact areas). For example, as illustrated in FIG. 7, two ring resonators 112 and 113 included in the first ring resonator G1 may be covered by the tuning clad patterns 152 and 153 with different areas.

According to this embodiment, a difference of ring radii of each of the groups G1 and G2 can generate a main difference of the resonant frequencies of the ring resonators included in each of the groups G1 and G2. A structural difference of the tuning clad patterns 152/153 or 252/253 of each of the groups G1 and G2 can generate a fine difference of the resonant frequencies of the ring resonators included in each of the groups G1 and G2.

According to the present invention, provided is a tuning clad pattern that covers a portion of a circumference of a ring resonator.

The tuning clad pattern is formed of a material having a refractive index less than that of a ring resonator core. In this case, since most of optical guided modes are distributed within the ring resonator core, a variation of a contact area between the tuning clad pattern and the ring resonator causes a fine variation of a resonant frequency of the ring resonator. Thus, unlike a typical technology in which the resonant frequency of the ring resonator has a large effect on a variation of a lithography process, the present invention can finely adjust the resonant frequency of the ring resonator without the burden of the process variation.

In addition, since the resonant frequency can be finely adjusted, the ring resonator according to the present invention can embody the resonant frequency with improved uniformity.

Therefore, the WDM device according to the present invention can have a dense and uniform channel spacing.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

1. A wavelength-division-multiplexing (WDM) device, comprising:
an input waveguide;
a plurality of ring resonators around the input waveguide;
a plurality of output waveguides disposed around the ring resonators, respectively; and
at least one tuning clad pattern adjacent to at least one of the ring resonators, the at least one tuning clad pattern covering only a portion of a surface of a corresponding ring resonator, the at least one tuning clad pattern being configured to cause a variation of a resonant frequency of the corresponding ring resonator.

2. The WDM device of claim 1, wherein, when at least two tuning clad patterns are provided, the tuning clad patterns being in contact with the ring resonators adjacent thereto, respectively, contact areas of the two tuning clad patterns being are different from each other.

3. The WDM device of claim 1, wherein the tuning clad pattern includes material having a refractive index that is less than that of the ring resonator.

4. The WDM device of claim 1, wherein the ring resonator is formed of silicon, and the tuning clad pattern is formed of at least one of inorganic materials and organic materials having a refractive index less than that of silicon.
wherein the inorganic materials comprise silicon dioxide and silicon nitride, and the organic materials comprise at least one of polymethyl methacrylate (PMMA)-based polymers, polyimide-based polymers, polyether-based polymers, and acrylate-based polymers.

5. The WDM device of claim 1, wherein the ring resonators are equal in shape, material, and size.

6. The WDM device of claim 1, wherein the ring resonators comprise at least one ring resonator group including at least one ring resonator,
the ring resonators included in one of the at least one ring resonator group are equal in shape, material, and size, and
the ring resonators included in the other ring resonator groups are different from with each other in at least one of shape, material, and size.

7. A WDM device comprising:
an input waveguide;
a plurality of ring resonators around the input waveguide;
a plurality of output waveguides around the ring resonators, respectively; and
a clad structure including at least one tuning clad pattern and an upper clad layer covering a surface of each of the ring resonators,
wherein the ring resonators are different from each other in a ratio of a contact area of the ring resonator and a corresponding tuning clad pattern to a contact area of the ring resonator and a corresponding upper clad layer, and
wherein the tuning clad pattern is disposed circumferentially adjacent to at least one ring resonator, so that at least a portion of the tuning clad pattern is provided between an inner surface of the ring resonator and a center of the ring resonator.

8. A wavelength-division-multiplexing (WDM) device, comprising:
an input waveguide;
a first ring resonator provided around a first portion of the input waveguide, the first ring resonator having a first radius;
a first output waveguide disposed proximate the first ring resonator;
a first tuning clad pattern coupled to the first ring resonator and configured to cooperate with the first ring resonator to extract light having a first frequency;
a second ring resonator provided around a second portion the input waveguide, the second ring resonator having a second radius that is substantially the same as the first radius;
a second output waveguide disposed proximate the second ring resonator;
a second tuning clad pattern coupled to the second ring resonator and configured to cooperate with the second ring resonator to extract light having a second frequency, the second frequency being different than the first frequency.

9. The device of claim 8, wherein the first tuning clad pattern and the first ring resonator define a first contact area, and the second tuning clad pattern and the second ring resonator define a second contact area, and
wherein the first contact area and the second contact area are used to define the first frequency and the second frequency, respectively.

10. The device of claim 9, wherein the first ring resonator has an inner surface and an outer surface, the inner surface being proximate a center of the first ring resonator, and
wherein the first tuning clad pattern is disposed circumferentially around the first ring resonator, so that at least a portion of the first tuning clad pattern is provided between the inner surface and the center of the first ring resonator.

11. The device of claim 8, wherein the first ring resonator has an inner surface and an outer surface, the inner surface being proximate a center of the first ring resonator, and
wherein at least a portion of the first tuning clad pattern is provided between the inner surface and the center of the first ring resonator.

12. The device of claim 11, wherein the first tuning clad pattern is provided on the first ring resonator.
